(19) United States
(12) Patent Application Publication
(10) Pub. No.: US 2012/0150808 A1
(43) Pub. Date: Jun. 14, 2012

(54) METHOD AND SYSTEM FOR PERFORMING DATA BACKUP AND RESTORATION

(75) Inventors: Paul Hubner, McKinney, TX (US); Robert A. Clavenna, Lucas, TX (US); Kristopher Pate, Flower Mound, TX (US); Steven T. Archer, Dallas, TX (US)

(73) Assignee: VERIZON PATENT AND LICENSING INC., Basking Ridge, NJ (US)

(21) Appl. No.: 12/966,712

(22) Filed: Dec. 13, 2010

(51) Int. Cl. G06F 12/16; G06F 17/30

(52) U.S. Cl. 707/652; 711/162; 711/E12.103; 707/E17.005

(57) ABSTRACT

An approach for enabling execution of data backup and restoration among a group of user devices is described. A data management platform detects at a source device, one or more peer devices capable of wireless communication with the source device. It then determines one or more of the peer devices as belonging to a backup device group according to a predetermined criterion. The data management platform 103 then designates data resident within the source device for backup and initiates transfer of the backup data to the backup device group over a wireless communication session.

### BACKGROUND INFORMATION

The applications and associated data that are resident within user devices, e.g., mobile phones, smartphone, netbooks, laptops, etc., require reliable methods to prevent the loss of such applications and data, as mobile devices are susceptible to physical damage from continual transport. For example, many of these devices are equipped with applications that may result in or require the generation of large files, including photos, music, digital books, documents and other rich data. Despite the large amount of data maintained on the devices, most users do not exhibit the regular habit of performing a manual backup of their device data despite the importance of doing so. In the rare instance they do, it is typically by way of physically connecting with another computer to perform synchronization, or through the use of external memory devices (i.e., secure digital cards). This manual process may not be performed regularly enough by the user, however, to ensure the availability of relevant and timely copies of the data. Consequently, when data on the device is lost or corrupted, the user may simply have to incur the cost and inconvenience of acquiring the data again (assuming such option is even possible).

Based on the foregoing, there is a need for effective, convenient execution of data backup and restoration for user devices.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system for enabling execution of data backup and restoration among a group of user devices, according to one embodiment;

FIG. 2 is a diagram of a data management platform for enabling execution of data backup and restoration among a group of user devices, according to one embodiment;

FIGS. 3A-3D are flowcharts of a process for enabling execution of data backup among a group of user devices, according to various embodiments;

FIGS. 4A and 4B are flowcharts of a process for enabling execution of data restoration among a group of user devices, according to various embodiments;

FIGS. 5A-5C are diagrams of a user interface for enabling a customer to execute data backup and data restoration among a group of user devices, according to one embodiment;

FIG. 6 is a diagram of a computer system that can be used to implement various exemplary embodiments; and

FIG. 7 is a diagram of a chip set that can be used to implement an embodiment of the invention.

### DESCRIPTION OF THE PREFERRED EMBODIMENT

An apparatus, method and software for enabling execution of data backup and restoration among a group of user devices is described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

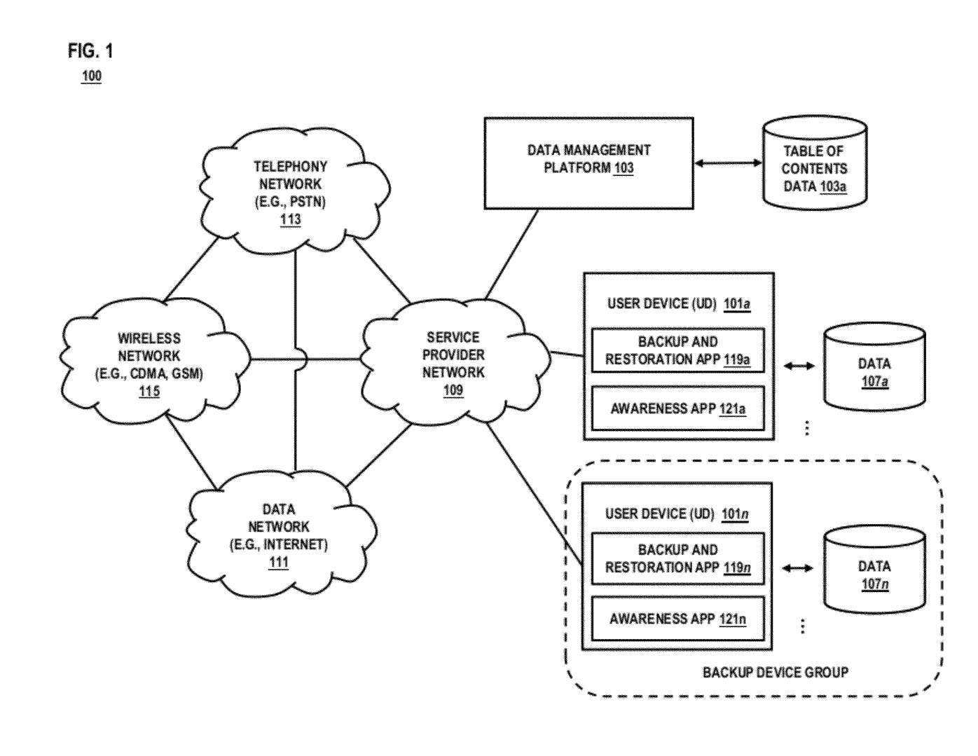

FIG. 1 is a diagram of enabling execution of data backup and restoration among a group of user devices, according to one embodiment. For the purposes of explanation, system 100 is shown to includes one or more user devices (UD) 101a-101n (e.g., mobile device, smartphone, etc.), which are configured to communicate with each other to share data on a peer-to-peer basis and to coordinate such transfer with a data management platform 103. The platform 103 in essence provides backup and restoration services to these devices 101a-101n. The data management platform 103 can facilitate peer-distributed, network-controlled data backup and restoration. In certain embodiments, “backup” of data pertains to the process generating copies of data, such as maintained by a computing device, so that additional copies of data may be used when a restoration of data is required. Data backup and subsequent restoration may be required for various reasons, including data loss, file corruption or even computing system failure. In one embodiment, the backup and restoration services are offered by a service provider as a managed service. The data management platform 103 enables any one of the user devices 101a-101n to initiate the restoration of data through one or more of the other devices belonging to a “backup device group” using wireless communications. As will be more fully described, the backup device group can include one or more peer user devices configured to participate in the service.

Typically, backup systems and software are configured to store the copies of data to a specified data storage, which, depending upon the requirements and capabilities of the user, may include network based storage solutions (e.g., online storage), external device mediums (e.g., external hard drive), or a combination thereof. While implementation approaches vary, backups may be performed in various ways, including by way of an initial or base backup. In another approach, a continuous backup may be performed wherein the data is subject to backup anytime it is altered, or the backup may be performed on a scheduled backup basis wherein the system only backs up the latest version of the data at a specified time. Still further, another backup process is a trickle out backup, wherein the data is backed up to a local folder (e.g., data stores of a given device), then copied to the final backup destination according to a defined trickle schedule. Regardless of the approach employed, data backup may be performed due to data loss, file corruption, computing system failure or the like. These techniques can be employed in conjunction with the peer-distributed, network-controlled data backup and restoration services of platform 103. smartphone

Information acquired or generated by user devices 101a-101n is initially stored to internal memory 107a-107n. Whether the user device 101 is a mobile phone, laptop, camera or other portable device, many of these devices are designed to generate or process data of all types, including photos, music, digital media, movies, documents and other data. As discussed, typical users are far from diligent in backing up data on their mobile devices, in large part, because of the manual process involved. Moreover, the backup process can be time consuming, particularly if the mobile device has not routinely been backed up (as data is generally backed up in increments).

To address this issue, system 100 of FIG. 1 enables computing devices, including those that are portable or dedicated, to automatically facilitate the data restoration process based on the established physical presence of the user devices 101a-101n. In addition, the data management platform 103 is configured to enable a group of peer devices 101a-101n belonging to a backup device group to regulate and manage the execution of the backup process. By way of these approaches, a source device (e.g., a requesting device of the backup device group) is able to ensure regular and timely performance of backups and/or restorations based in part on the detection of associated peer devices.

Moreover, the data management platform 103 maintains registration data (not shown) regarding the various registered users and peer user devices 101a-101n. The registration data may include various information for associating the devices with the applicable service offerings (e.g., function and features) afforded by the platform 103, including a registration identifier, user name and identifier, device name and type, device identifier, data sharing preferences, service level preferences, etc. The profile data may also indicate various permission settings of the registered device users, such as permission to enable the data management platform 103 to initiate data transfer among a designated group of peers of the backup device group upon demand.

In one embodiment, when one or more peer user devices 101a-101n are registered with the data management platform 103, they are able to interact with one another for automatically invoking data backup and restoration upon request. By way of example, when user devices 101a-101n are detected as being within range of one another, the data management platform 103 causes one or more of them to initiate backup of data stored in respective memory 107a-107n to the other peer devices 101a-101n. In certain embodiments, range detection and presence is determined by way of an awareness application 121a-121n that runs in connection with the operating system of respective devices 101a-101n. The awareness application 121 has visibility to the various signals detected by the integrated sensory systems of the peer user devices 101a-101n, including Bluetooth signals, WiFI broadcasts, audio signals, internet protocol (IP) stack data (e.g., IP address data) associated with a mutually configured local or wide area communication network, and any other signals or metrics produced as a result of range based communication protocols. As such, peer devices may detect each other's presence without indicating or identifying the end user.

By detecting presence, the awareness application 121a-121n or respective peer devices can also determine which peers make regular or frequent contact with one another. The determination can be based on a preset threshold or statistically determined, i.e., as based on proximity tendencies, average number of interactions, etc. It is noted that this information may be useful for defining/establishing peers that comprise the backup device group—i.e., a group of user devices configured to and subscribed with the data management platform 103 for enabling data backup or restoration. These metrics may be gathered or computed by the data management platform 103 accordingly, such as for regulating the data sharing and exchange process.

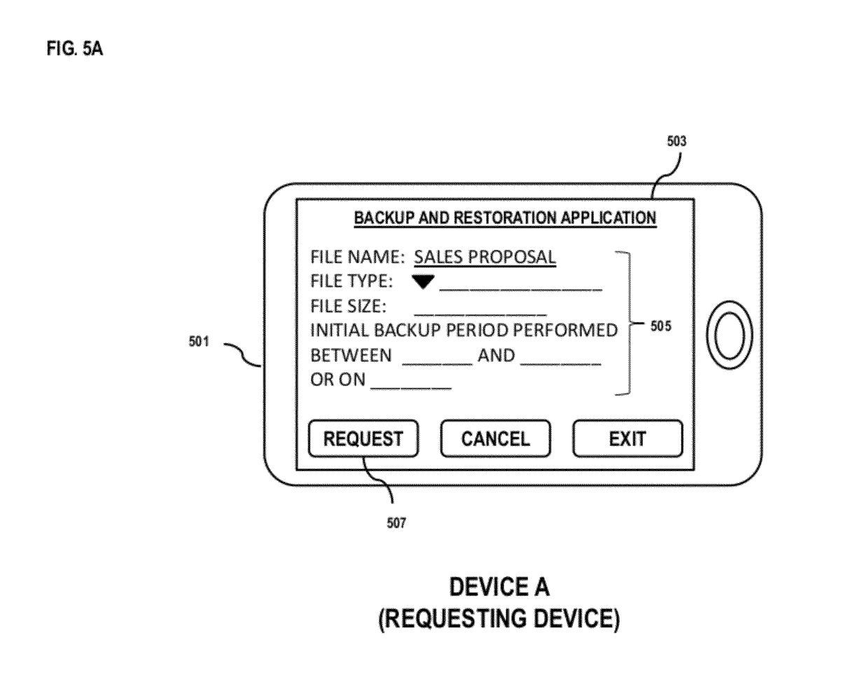

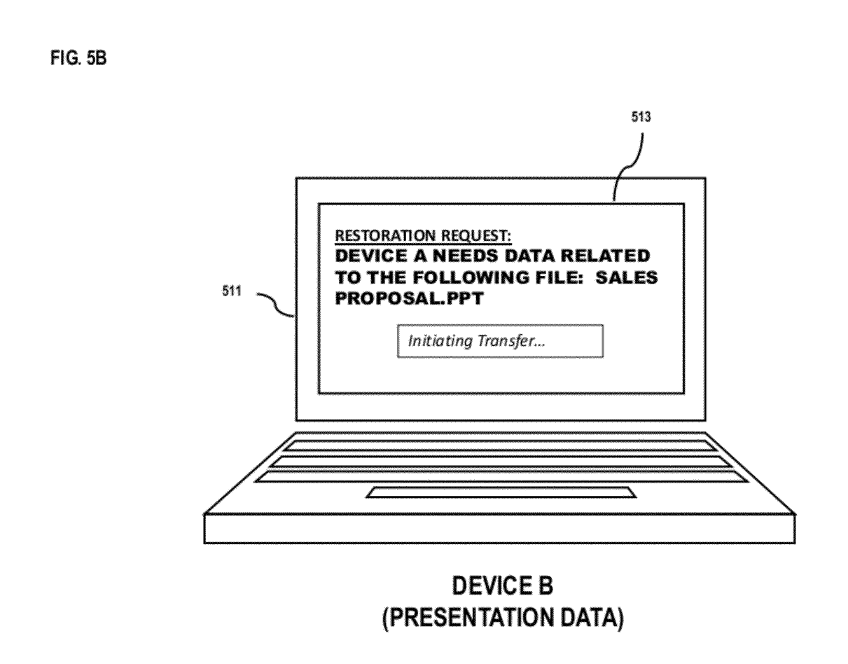

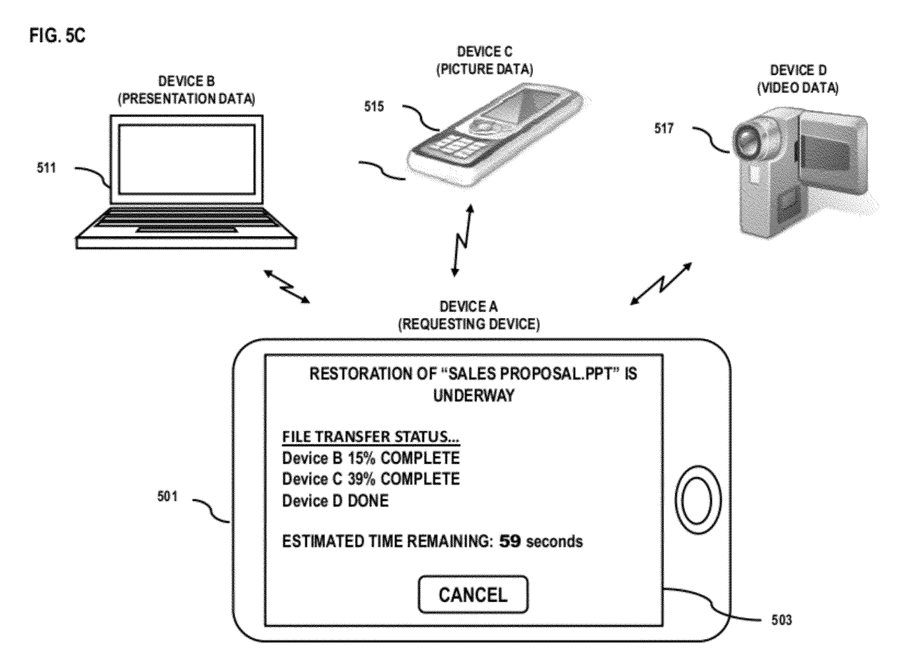

Also, in certain embodiments, a backup and restoration application 119a-119n may be configured to access the data management platform 103 to enable data backup or restoration. By way of example, the backup and restoration application 119a-119n may provide a user interface (UI) for enabling a backup and/or restore request to be made or for adapting specific backup and/or restoration policies, priorities and settings. The backup and restoration application 119a-119n may also present the current status of a backup or restoration operation that is underway to the UIs of associated peer user devices 101a-101n as well provide notifications regarding an operation request (e.g., a message indicating that a peer device needs access to a particular set of data maintained by the backup device group). More regarding the execution of specific UIs for carrying out the backup and restoration process among peers is presented later, by way of example, with respect to FIGS. 5A-5C.

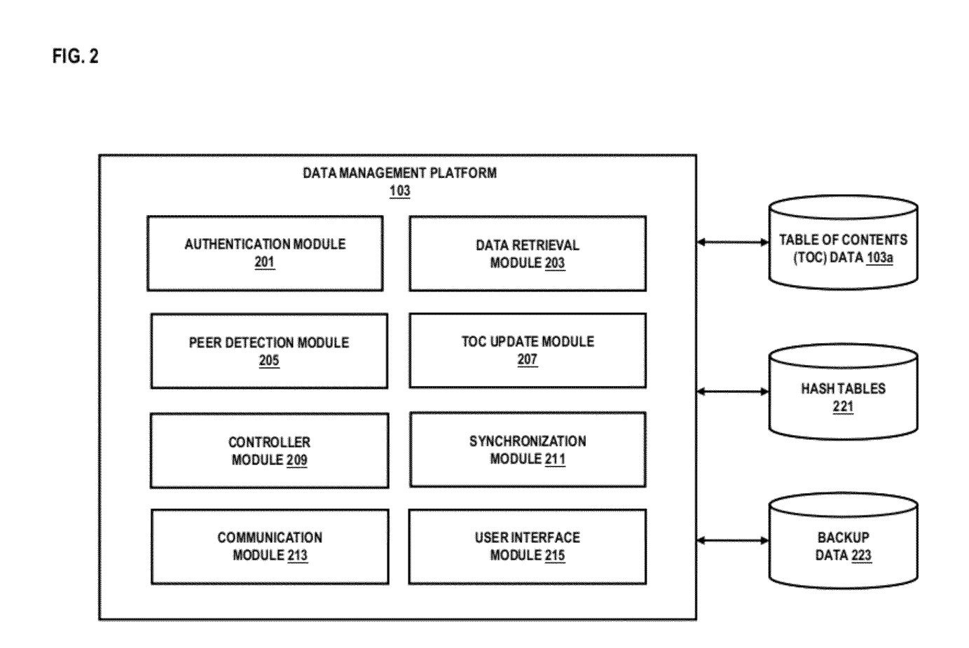

The backup and restoration application 119a-119n, in connection with the awareness application 121a-121n, keeps track of when and where a backup operation was requested or performed by respective peer user devices 101a-101n. For example, as data can be repeatedly transferred between devices in whole or part (e.g., chunks of data at a time according to a trickle down backup process), a table of contents (TOC) log pertaining to the backup activity is maintained by the data management platform 103. In certain embodiments, the TOC allows the data management platform 103 to keep track of the sequence of a backup and/or restoration operation, including which devices correspond to specific segments of data comprising the target data set, which devices are the source of a target set of data, and other information necessary for properly reproducing and reconstructing desired data. As will be discussed further with respect to FIG. 2, the TOC data 103a is generated based in part on metadata provided to the data management platform 103 during execution of a backup or restoration request. It may be further translated into a hash table for use by the data management platform 103.

To perform data restoration, a source peer device (e.g., one of user devices 101) initiates the process by requesting the retrieval of data maintained by the backup device group (e.g., user devices 101a-101n). The source device informs the data management platform 103 of the restoration request, which in turn, determines the availability of the backup device group. By way of example, this may include referencing the TOC information in order to determine which devices of the backup device group maintain the backup data, assessing the presence of the peer devices relative to the source, or a combination thereof. In addition, the data management platform 103 may transmit the TOC data 103a to the device for enabling the device to be aware of the correct devices, data chunks and sequences required for acquisition of the data. Having been prompted as such by the data management platform 103, when the required devices of the backup peer group are within range of the source device, the files or file segments as requested are initiated for transfer. It is noted that in certain instances, the data is provided by the backup device group, the data management platform 103, or a combination thereof. The process may be performed as a bulk return restoration, wherein the platform 103 returns data over a communication network (e.g., WAN) while peers of the backup device return data directly via a local area network (LAN), private area network (PAN) or the like.

It is noted that user devices 101a-101n, also referred to as peer user devices 101, may be any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), smartphone or any combination thereof. It is also contemplated that the user devices 101a-101n can support any type of interface for supporting the presentment or exchanging of data. In addition, user devices 101a-101n may facilitate various input means for receiving and generating information, including touch screen capability, keyboard and keypad data entry, voice-based input mechanisms and the like. Any known and future implementations of user devices 101 are applicable.

In certain embodiments, user devices 101a-101n, the data management platform 103 and other elements of system 100 may be configured to communicate via a service provider network 109. According to certain embodiments, one or more networks, such as data network 111, telephony network 113, and/or wireless network 115, can interact with the service provider network 109. Networks 109-115 may be any suitable wireline and/or wireless network, and be managed by one or more service providers. For example, telephony network 113 may include a circuit-switched network, such as the public switched telephone network (PSTN), an integrated services digital network (ISDN), a private branch exchange (PBX), or other like network. Wireless network 115 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 111 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 109-115 may be completely or partially contained within one another, or may embody one or more of the aforementioned infrastructures. For instance, service provider network 109 may embody circuit-switched and/or packet-switched networks that include facilities to provide for transport of circuit-switched and/or packet-based communications. It is further contemplated that networks 109-115 may include components and facilities to provide for signaling and/or bearer communications between the various components or facilities of system 100. In this manner, networks 109-115 may embody or include portions of a signaling system 7 (SS7) network, or other suitable infrastructure to support control and signaling functions.

According to exemplary embodiments, end user devices (not shown) may be utilized to communicate over system 100 and may include any customer premise equipment (CPE) capable of sending and/or receiving information over one or more of networks 109-115. For instance, voice terminal may be any suitable plain old telephone service (POTS) device, facsimile machine, etc., whereas mobile device (or terminal) may be any cellular phone, radiophone, satellite phone, smart phone, wireless phone, or any other suitable mobile device, such as a personal digital assistant (PDA), pocket personal computer, tablet, customized hardware, etc. Further, computing device may be any suitable computing device, such as a VoIP phone, skinny client control protocol (SCCP) phone, session initiation protocol (SIP) phone, IP phone, personal computer, softphone, workstation, terminal, server, etc.

It is noted, though not shown in the figure, that in certain embodiments user devices 101a-101n may be configured to establish peer-to-peer communication sessions with each other using a variety of technologies—near field communication (NFC), Bluetooth, infrared, etc. Also, connectivity can be provided via a wireless local area network (LAN). By way of example, a group of user devices 101a-101n may be configured to a common LAN so that each device can be uniquely identified via any suitable network addressing scheme. For example, the LAN may utilize the dynamic host configuration protocol (DHCP) to dynamically assign “private” DHCP internet protocol (IP) addresses to each user device 101, i.e., IP addresses that are accessible to devices connected to the service provider network 109 as facilitated via a router.

FIG. 2 is a diagram of a data management platform for enabling execution of data backup and restoration among a group of user devices, according to one embodiment. The data management platform 103 includes various executable modules for performing one or more computing, data processing and network based instructions that in combination provide a means of configuring devices for operation as a backup peer group. Such modules can be implemented in hardware, firmware, software, or a combination thereof. By way of example, the data management platform 103 may include a authentication module 201, data retrieval module 203, peer detection module 205, TOC update module 207, controller module 209, synchronization module 211, communication module 213 and user interface module 215. In addition, the data management platform 103 also maintains table of contents (TOC) data, hash table data 221 for mapping various data sets (chunks) with associated values (e.g., a requesting peer device) of the TOC through execution of a hash function, and backup data as provided by devices of the backup device group.

In one embodiment, the user interface module 215 enables presentment of data as conveyed by or generated by the data management platform to a graphical user interface of a user device 101. By way of example, the user interface module 215 generates notification or status messages to the user interface in response to application programming interfaces (API) or other function calls corresponding to a web browser application or web portal of the computing device. Under this scenario, the user interface module is configured to generate appropriate control signals for enabling display of graphical and textual elements. It is noted the user interface may also be generated for enabling user entry of backup or restoration request related information.

In one embodiment, a communication module 213 enables formation of a session over a network 109 between the data management platform 103 and the various user devices 101a-101n comprising a backup device group. Various protocols and data sharing techniques for enabling collaborative execution between a computing device (e.g., mobile devices, laptops, smartphones, tablet computers, desktop computers) and the platform 103 over the communication network is provided by the module 213. By way of example, the communication module 213 may regulate operation of a pop-up message at the interface of associated devices in connection with user interface module.

In one embodiment, an authentication module 201 authenticates users and user devices 101a-101n for interaction with the data management platform 103. By way of example, the authentication module 201 receives a request to subscribe to the data management service for enabling seamless backup and restoration of data in response to the presence and/or availability of peer devices containing the required data. The subscription process may include enabling respective peer device users to establish an opt-in feature, wherein devices belonging to a peer group confirm their peers before transferring any data. Alternatively, they may opt-out to enable this process to occur without requiring confirmation (automatically). These settings are appropriately handled by the authentication module 201.

Authentication may include receiving and validating a login name and/or user identification value as provided or established for a particular user during a subscription or registration process with the service provider. The login name and/or user identification value may be received as input provided by the user by way of the user device 101 or other device via a graphical user interface to the platform 103 (e.g., as enabled by user interface module 215). Alternatively, the login process may be performed through automated association of profile settings with an identification signal generated by an active device, i.e., a carrier detection signal. Still further, the authentication module 201 may also be configured to receive requests from various devices for activation of data backup or restoration. By way of this approach, having authenticated the device, the authentication module 201 alerts the synchronization module 211 of the backup or restoration request. In addition, the authentication module passes the request on to a data retrieval module 203 for parsing the request accordingly to enable proper data synchronization according to the conditions of the request.

In one embodiment, the data retrieval module 203 parses a backup or restoration request for metadata as well as data to be backed up. The metadata retrieved by the module 203 pursuant to the request may include the following information (per Table 1):

TABLE 1

| | |
|---|---|
| i. | A “table of contents” entry and hash table representative of the data |
| | that is backed up; |
| ii. | A date of update, creation or entry to the TOC 103a/hash table 221; |
| iii. | A time of update, creation or entry to the TOC 103a/hash table 221; |
| iv. | An identifier (e.g., associated IP address, device ID) associated with |
| | the peer device requesting the backup; |
| v. | A backup redundancy setting (e.g., the number of distributed copies |
| | of data); |
| vi. | Peer related data and statistics, i.e., success rate of transfers to each |
| | device comprising the backup device group, storage capacity of |
| | respective devices, processing capabilities, etc.; |
| vii. | Size (e.g., in bytes) of a given data chunk; and |
| viii. | Data type and priority information |

It is noted that the metadata can be much smaller than the actual data that is backed up. Additional information may also be provided other than that shown above.

The data retrieval module 203 may also receive data pertaining to the regularity of peer contact with the requesting (source) peer device. As mentioned previously, by way of this approach, data regarding peer contact and interaction may be provided directly by respective devices, or optionally, performed by a peer detection module 205. The peer detection module 205, in one embodiment, may be configured to trigger the detection of peer devices associated with a restoration request, so as to enable seamless activation of the restoration process. By way of example, the peer detection module 205 may generate a signal for causing a group of devices containing requested data to periodically search for, track, find or be aware of the requesting device. The restoration process is then triggered based on the detection of the suggested peer. It is noted that this module 203 may execute in connection with or in place of an awareness application 121 of a given user device 101. Furthermore, it is contemplated that the peer detection module 203 may also be configured to enable Global Positioning System (GPS) monitoring and tracking of subscribed user devices.

In one embodiment, a TOC update module 207 updates the table of contents information as provided as part of a backup or restoration request. In addition, the TOC module updates the TOC based on the performance of a backup or restoration operation. In both of these instances, a hash table 221 may be generated or refined through execution of a hash function that enables expedited processing of the TOC data and for associating data as stored to respective backup procedures. By way of example, the TOC update module 207 refines a TOC and hash table 221 in response to a performed backup operation so that the data management platform 103 may keep coordinate the assembly of the correct data chunks corresponding to a backup or restoration request. Likewise, additional entries to the TOC 103a or hash table 221 may be made according to the receipt of metadata and data to be backed up by (e.g., additional chunks or portions of data).

In one embodiment, a synchronization module 211 may operate in connection with the peer detection module 205 to trigger automated backup and/or restoration operations based on the determined presence of the required peer devices within range of one another. By way of this approach, the synchronization module 211 generates a control signal for prompting the devices of the backup device group having access to the necessary data to initiate transmission of the data to the requesting device when present. Alternatively, for smaller data requests or in instances where the devices housing the information are not available, the synchronization module 223 may send the data 223 directly.

Additionally, in one embodiment, a controller module 209 is configured to regulate the communication processes between the various other modules. For example, the controller module 209 generates the appropriate signals to control the communication module 213 for facilitating transmission of data over the service provider network 109. Also, the controller module 209 may regulate the accessing of the various data repositories 103a, 221 and 223 by a given module.

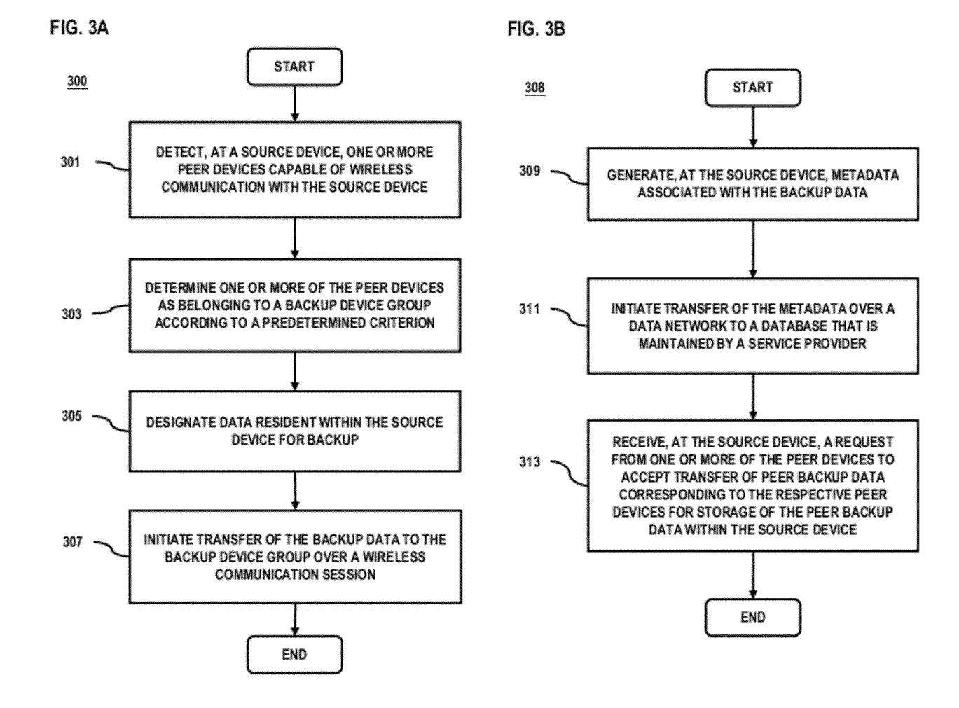

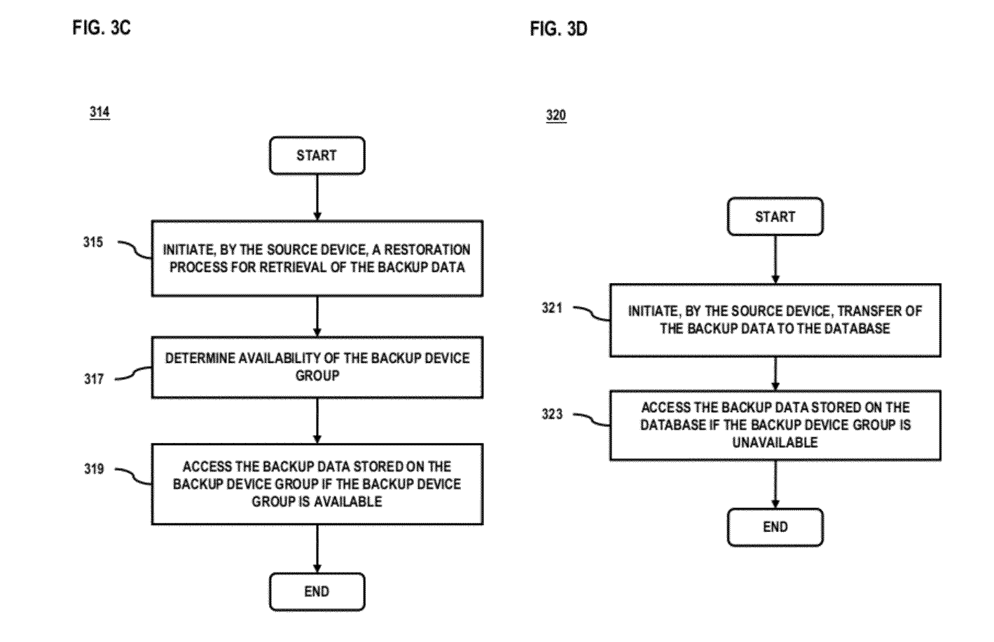

FIGS. 3A-3D are flowcharts of a process for enabling execution of data backup among a group of user devices, according to various embodiments. For the purpose of illustration, the processes are described with respect to FIG. 1. It is noted that the steps of the process may be performed in any suitable order, as well as combined or separated in any suitable manner. In step 301 of process 300, a source device detects one or more peer devices capable of wireless communication with the source device. In step 303, a determination is made as to whether one or more of the peer devices belong to a backup device group 101a-101n according to predetermined criterion. As mentioned above, the predetermined criterion may include statistics or metrics for indicating the regularity of contact or presence of respective members of the backup device group 101a-101n with respect to one another.

Per steps 305 and 307 respectively, data resident within the source device may be designated for backup, and transfer of the backup data may be initiated to the backup device group. It is noted that the designation process and transfer process may be carried out by the data management platform 103 in conjunction with one or more devices of the backup device group.

With respect to FIG. 3B, in step 309 of process 308, metadata associated with the backup data is generated, such as by the source device. As mentioned, the metadata may include various details regarding the data to be backed up or the backup request to enable the data management platform 103 to formulate or refine a TOC 103a and hash table associated with the data. In step 311, transfer of the metadata is initiated over a data network to a database maintained by a service provider, i.e., the data management platform 103. Per step 313, a request from one or more of the peer devices to accept transfer of peer backup data is received at the source device. It is noted that the request is intended to enable respective peer devices to store the backup data to the source device.

In FIG. 3C, per step 315 of process 314, a restoration process for retrieval of backup data is initiated by the source device. In step 317, the availability of the backup device group is determined. As noted, this may be performed through detection means such as an awareness application 121 at the peer devices, or as performed by the data management platform 103. Per another step 319, the backup data on the backup device group is accessed if the backup device group is available.

Per step 321 process 320, as presented with respect to FIG. 3D, the source device initiates transfer of the backup data to the database maintained by the data management platform. In step 323, the backup data stored at the database as maintained by the data management platform 103 is accessed if the backup device group is unavailable.

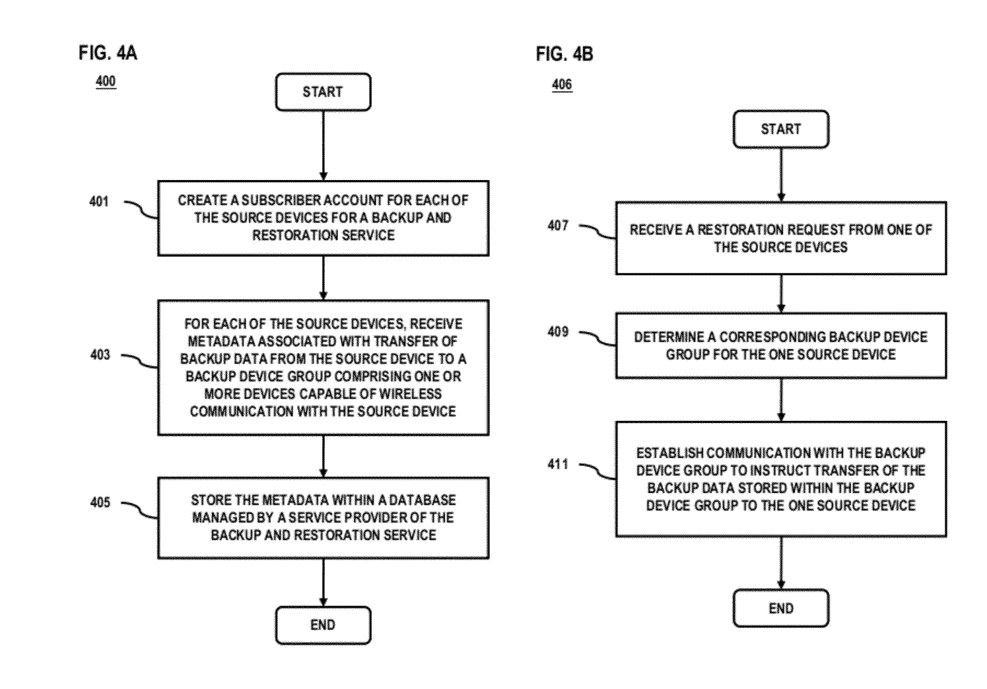

FIGS. 4A and 4B are flowcharts of a process for enabling execution of data restoration among a group of user devices, according to various embodiments. For the purpose of illustration, the processes are described with respect to FIG. 1. It is noted that the steps of the process may be performed in any suitable order, as well as combined or separated in any suitable manner. In step 401 of process 400, a subscriber account is created for each of the source devices for a backup and restoration service. Of note, the source devices (e.g., user devices 101a-101n) may interact with the data management platform 103 for enabling the subscription process.

Per step 403, metadata associated with the transfer of backup data from the source device to a backup device group is received for each of the source devices. As mentioned, each source device requires receipt of the data for fulfillment of a restoration operation. The backup device group comprises one or more devices capable of wireless communication with the source device. In another step 405, metadata is stored within a database of the data management platform 103, as managed by a service provider of the backup and restoration service.

With respect to FIG. 4B, in step 407 of process 406, a data restoration request is received from one of the source devices. As described, the request may be processed by the data management platform 103 for initiating and coordinating the restoration process among the group of peer devices. In step 409, a determination is made as to a corresponding backup device group for the one source device. Per step 411, the data management platform 103 establishes communication with the backup device group to instruct transfer of the backup data stored with the backup device group to the one source device.

FIGS. 5A-5C are diagrams of a user interface for enabling a customer to execute data backup and data restoration among a group of user devices, according to one embodiment. For the purpose of illustration, the diagrams are described with respect to an exemplary user case of a device group comprising multiple peer devices. FIG. 1. It is noted that while the user interface depictions correspond to the process of backup restoration, the devices may be configured to cause presentment of various additional screens based on interaction of devices with the data management platform 103.

In FIG. 5A, a source device 501 (Device A) accesses the backup and restoration application 119 by way of its user interface 503. A user may invoke the application 119 for enabling communication over the network with the data management platform 103 for initiating data restoration. Various criteria may be input to the application for formulating the request, as indicated by data fields 505, including a specified file name, file type, file size, a period in which an initial backup of the data was performed, or a specific date of backup by the backup device group. By way of example, the user may enter as a file name “Sales Proposal” and indicate a file type of “*.PPT” for indicating that the restoration process corresponds to acquisition of data related to this particular presentation. The user may enter as many variables (criteria) as they are familiar with and then transfer the request along with metadata comprising such variables, to the data management platform 103. The request is enabled by activating a “Request” action button 507. It is noted that under this scenario, Device A acts as a source device.

In FIG. 5B, a computing device 513 corresponding to Device B of the backup device group receives a restoration request message, such as generated by the data management platform 103 responsive to the request as submitted. The message is presented to the user interface 513 of the device 511 for indicating the specific requesting device requiring the data as well as the data being requested. As mentioned above, the computing device 511 upon notification is caused to initiate the transfer process of the requested data source Device A based on determined presence of respective devices. It is noted in this example scenario that Device B contains presentation data (e.g., slides) pertaining to the requested file “Sales Proposal.ppt,” and that other data pertaining to the restoration is held by other devices of the backup device group. Thus, in certain embodiments, the data restoration process may be fulfilled by a single device of the group, or alternatively, the data may be distributed across multiple different devices (e.g., chunks of data comprising a total data set are maintained by different devices).

In FIG. 5C, additional devices comprising the group include Device C and Device D, corresponding to a mobile phone 515 having an integrated camera feature and a video recorder device 517. By way of example, Device C 515 maintains picture data associated with the requested presentation, while Device D maintains the required video data of the presentation. The data management platform 103, under this scenario, references the TOC to determine the location of the required data for fulfilling the request. It then prompts execution of the data transfer process from respective devices B, C and D upon each device being within range of source Device A. As noted, the devices are within range by way of their availability to communicate via a communication network (e.g., LAN, PAN, etc.), such as detected via an awareness application.

As the backup data/file transfer process is occurring, the UI 503 of source Device A (device 501) may present the user with status information pertaining to the restoration. By way of example, a message may be provided for indicating that “Restoration of ‘Sales Proposal.ppt’ is underway. In addition, the Devices B-D involved in fulfilling the restoration request, along with respective percentage completion status may also be presented. Still further, an estimated time remaining for completion of the overall restoration process may be presented. It is noted that the completion times of respective backup data transfer may vary from one device to the next depending on the amount of data to be transferred to the source, relative connection characteristics and other factors. Also, of note, the data management platform 103 may transmit the data when one or Devices B-D is unavailable (not present) or when it is faster to do so (e.g., the amount of data to be provided for fulfilling the request is small in size).

The exemplary techniques and systems presented herein, according to certain embodiments, enable seamless execution of data backup and restoration among a group of devices comprising a backup device group. A data management platform 103 is configured to manage and coordinate the backup request and restoration process based on the availability or presence of respective group devices. Moreover, the data management platform 103 may cause the initiation of a data transfer to a requesting device without requiring the use of loadable memory devices (e.g., secure digital (SD) cards) or significant user intervention beyond the point of initiating a request. Such arrangement advantageously provides convenience to users of the devices 101a-101n to backup and restore important data and applications.

The processes described herein for providing peer-distributed, network-controlled data backup and restoration may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

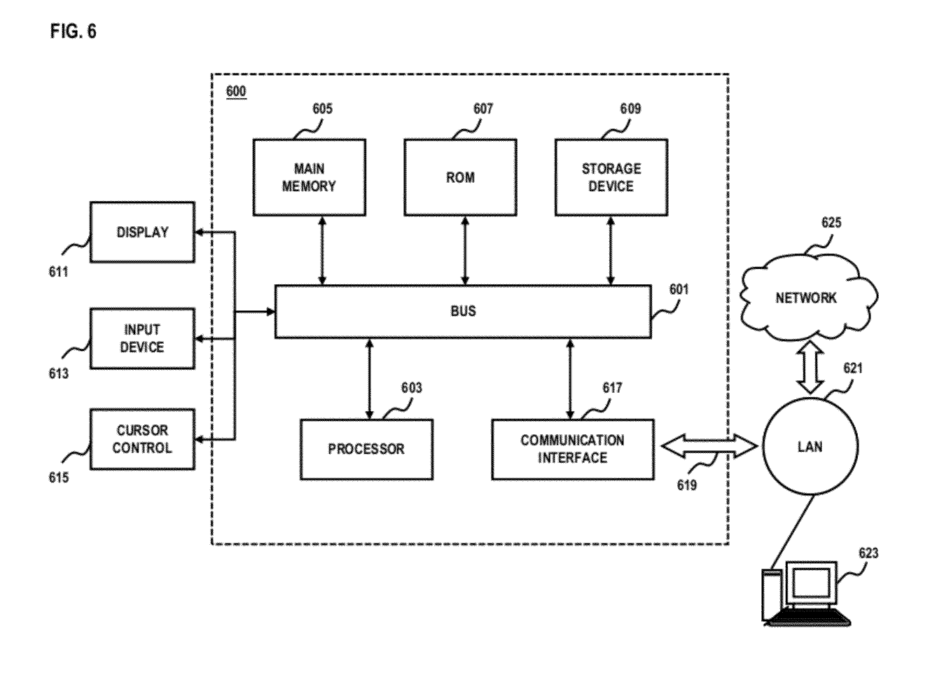

FIG. 6 is a diagram of a computer system that can be used to implement various exemplary embodiments. The computer system 600 includes a bus 601 or other communication mechanism for communicating information and one or more processors (of which one is shown) 603 coupled to the bus 601 for processing information. The computer system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions by the processor 603. The computer system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computer system 600 may be coupled via the bus 601 to a display 611, such as a cathode ray tube (CRT), liquid crystal display, active matrix display, or plasma display, for displaying information to a computer user. An input device 613, such as a keyboard including alphanumeric and other keys, is coupled to the bus 601 for communicating information and command selections to the processor 603. Another type of user input device is a cursor control 615, such as a mouse, a trackball, or cursor direction keys, for communicating direction information and command selections to the processor 603 and for adjusting cursor movement on the display 611.

According to an embodiment of the invention, the processes described herein are performed by the computer system 600, in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the embodiment of the invention. Thus, embodiments of the invention are not limited to any specific combination of hardware circuitry and software.

The computer system 600 also includes a communication interface 617 coupled to bus 601. The communication interface 617 provides a two-way data communication coupling to a network link 619 connected to a local network 621. For example, the communication interface 617 may be a digital subscriber line (DSL) card or modem, an integrated services digital network (ISDN) card, a cable modem, a telephone modem, or any other communication interface to provide a data communication connection to a corresponding type of communication line. As another example, communication interface 617 may be a local area network (LAN) card (e.g. for Ethernet™ or an Asynchronous Transfer Model (ATM) network) to provide a data communication connection to a compatible LAN. Wireless links can also be implemented. In any such implementation, communication interface 617 sends and receives electrical, electromagnetic, or optical signals that carry digital data streams representing various types of information. Further, the communication interface 617 can include peripheral interface devices, such as a Universal Serial Bus (USB) interface, a PCMCIA (Personal Computer Memory Card International Association) interface, etc. Although a single communication interface 617 is depicted in FIG. 6, multiple communication interfaces can also be employed.

The network link 619 typically provides data communication through one or more networks to other data devices. For example, the network link 619 may provide a connection through local network 621 to a host computer 623, which has connectivity to a network 625 (e.g. a wide area network (WAN) or the global packet data communication network now commonly referred to as the “Internet”) or to data equipment operated by a service provider. The local network 621 and the network 625 both use electrical, electromagnetic, or optical signals to convey information and instructions. The signals through the various networks and the signals on the network link 619 and through the communication interface 617, which communicate digital data with the computer system 600, are exemplary forms of carrier waves bearing the information and instructions.

The computer system 600 can send messages and receive data, including program code, through the network(s), the network link 619, and the communication interface 617. In the Internet example, a server (not shown) might transmit requested code belonging to an application program for implementing an embodiment of the invention through the network 625, the local network 621 and the communication interface 617. The processor 603 may execute the transmitted code while being received and/or store the code in the storage device 609, or other non-volatile storage for later execution. In this manner, the computer system 600 may obtain application code in the form of a carrier wave.

The term “computer-readable medium” as used herein refers to any medium that participates in providing instructions to the processor 603 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

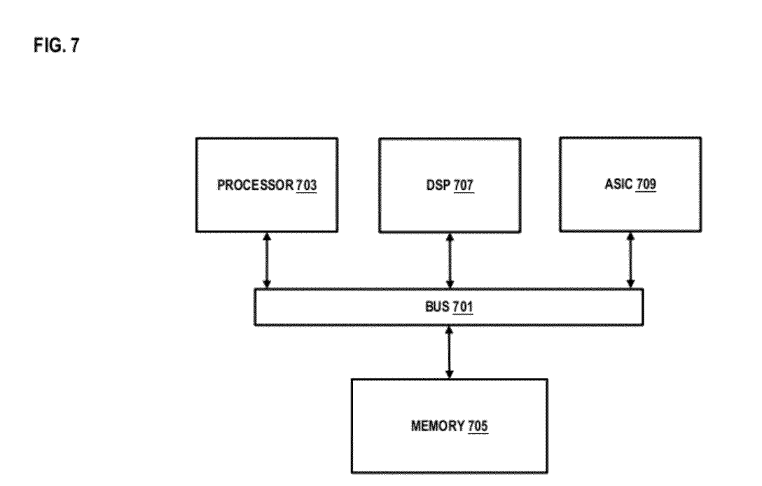

FIG. 7 illustrates a chip set or chip 700 upon which an embodiment of the invention may be implemented. Chip set 700 is programmed to enable execution of data backup and restoration among a group of user devices as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of enabling execution of data backup and restoration among a group of user devices.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 700 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to enable execution of data backup and restoration among a group of user devices. The memory 705 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
detecting, at a source device, one or more peer devices capable of wireless communication with the source device;
determining one or more of the peer devices as belonging to a backup device group according to a predetermined criterion;
designating data resident within the source device for backup; and
initiating transfer of the backup data to the backup device group over a wireless communication session.

2. A method according to claim 1, further comprising:
generating, at the source device, metadata associated with the backup data; and
initiating transfer of the metadata over a data network to a database that is maintained by a service provider.

3. A method according to claim 2, further comprising:
initiating, by the source device, a restoration process for retrieval of the backup data;
determining availability of the backup device group; and
accessing the backup data stored on the backup device group if the backup device group is available.

4. A method according to claim 3, further comprising:
initiating, by the source device, transfer of the backup data to the database; and
accessing the backup data stored on the database if the backup device group is unavailable.

5. A method according to claim 2, wherein the source device is associated with a subscriber account managed by the service provider as part of subscription to a backup and restoration service.

6. A method according to claim 1, wherein the predetermined criterion relates to frequency of contact between the source device and the one or more of the peer devices.

7. A method according to claim 1, wherein the transfer of the backup data is initiated without input from a user of the source device, and the backup device group is unknown to the user.

8. A method according to claim 1, further comprising:
receiving, at the source device, a request from one or more of the peer devices to accept transfer of peer backup data corresponding to the respective peer devices for storage of the peer backup data within the source device.

9. An apparatus comprising:
at least one processor; and
at least one memory including computer program code for one or more programs,
the at least one memory and the computer program code configured to, with the at least one processor, cause the apparatus to perform at least the following,
detect, at a source device, one or more peer devices capable of wireless communication with the source device,
determine one or more of the peer devices as belonging to a backup device group according to a predetermined criterion,
designate data resident within the source device for backup, and
initiate transfer of the backup data to the backup device group over a wireless communication session.

10. An apparatus according to claim 9, wherein the apparatus is further caused to:
generate, at the source device, metadata associated with the backup data; and
initiate transfer of the metadata over a data network to a database that is maintained by a service provider.

11. An apparatus according to claim 10, wherein the apparatus is further caused to:
initiate, by the source device, a restoration process for retrieval of the backup data;
determine availability of the backup device group; and
access the backup data stored on the backup device group if the backup device group is available.

12. An apparatus according to claim 11, wherein the apparatus is further caused to:
initiate, by the source device, transfer of the backup data to the database; and
access the backup data stored on the database if the backup device group is unavailable.

13. An apparatus according to claim 10, wherein the source device is associated with a subscriber account managed by the service provider as part of subscription to a backup and restoration service.

14. An apparatus according to claim 9, wherein the predetermined criterion relates to frequency of contact between the source device and the one or more of the peer devices.

15. An apparatus according to claim 9, wherein the transfer of the backup data is initiated without input from a user of the source device, and the backup device group is unknown to the user.

16. An apparatus according to claim 9, wherein the apparatus is further caused to:
receive, at the source device, a request from one or more of the peer devices to accept transfer of peer backup data corresponding to the respective peer devices for storage of the peer backup data within the source device.

17. A method comprising:
creating a subscriber account for each of a plurality of source devices for a backup and restoration service;
for each of the source devices, receiving metadata associated with transfer of backup data from the source device to a backup device group comprising one or more devices capable of wireless communication with the source device; and
storing the metadata within a database managed by a service provider of the backup and restoration service.

18. A method according to claim 17, further comprising:
receiving a restoration request from one of the source devices;
determining a corresponding backup device group for the one source device; and
establishing communication with the backup device group to instruct transfer of the backup data stored within the backup device group to the one source device.

19. An apparatus comprising:
at least one processor; and
at least one memory including computer program code for one or more programs,
the at least one memory and the computer program code configured to, with the at least one processor, cause the apparatus to perform at least the following,
create a subscriber account for each of a plurality of source devices for a backup and restoration service,
for each of the source devices, receive metadata associated with transfer of backup data from the source device to a backup device group comprising one or more devices capable of wireless communication with the source device, and
store the metadata within a database managed by a service provider of the backup and restoration service.

20. An apparatus according to claim 19, wherein the apparatus is further caused to:
receive a restoration request from one of the source devices;
determine a corresponding backup device group for the one source device; and
establish communication with the backup device group to instruct transfer of the backup data stored within the backup device group to the one source device.
